(19) United States
(12) Patent Application Publication
(10) Pub. No.: US 2025/0173573 A1
(43) Pub. Date: May 29, 2025

(54) RECURRENT NEURAL NETWORK TRAINING WITH HISTORY

(71) Applicant: Arm Limited, Cambridge (GB)

(72) Inventors: Ridhwanul Haque, Manchester (GB); Liam James O'Neil, Bedale (GB); Yanxiang Wang, Manchester (GB); Joshua James Sowerby, London (GB); Maxim Novikov, Sale (GB)

(21) Appl. No.: 18/521,286

(22) Filed: Nov. 28, 2023

(51) Int. Cl. G06N 3/084; G06N 3/044

(52) U.S. Cl. CPC G06N 3/084; G06N 3/044

(57) ABSTRACT

A persistent history buffer may be maintained in training a recurrent neural network such that information from at least one prior group of sequential training parameters within a training sequence is maintained for a subsequent group of training parameters. The persistent history buffer may be provided as an input to the recurrent neural network, and may store a history of a state of the recurrent neural network such as an input, an output and/or the state of a hidden layer. The persistent history buffer may be reset at the end of a sequence of input training parameters, which in a further example may span training input windows and/or batches.

### FIELD

The field relates generally to training neural networks, and more specifically to training recurrent neural networks using a history buffer.

### BACKGROUND

Neural networks are networks of nodes inspired by the function of neurons in the human brain, in which the interconnections between network nodes can be varied or altered during a training process to perform various functions. Neural networks are often considered an artificial intelligence or machine learning tool, as the neural network can be trained on a set of training data in an automated way to learn to process data to provide a desired output.

Neural networks are typically made up of layers of nodes or artificial neurons having connections to other nodes, including input nodes, hidden or intermediate nodes, and output nodes. Nodes may receive signals such as from one or more other nodes and compute a non-linear function of the sum of its inputs to generate an output, which may be provided to other nodes or to an output of the neural network. Nodes typically have weights for connections between each pair of nodes that are adjusted as training proceeds, and may have a threshold such that a signal is sent only if the aggregate signal crosses the threshold.

Training sets of inputs and desired outputs can be used with methods such as backpropagation of differences between the desired output provided as part of the training set and the predicted output generated by the neural network to improve the neural network's ability to generate the desired output for a given set of input data. When differences are backpropagated through the neural network, the node connection weights are adjusted based on the differences to improve the network's ability to generate the desired result, or to train the network.

Many neural network architectures exist, from conventional neural networks with input layers connected to one or more hidden layers that are eventually connected to an output layer, with signals being fed forward from nodes in any given layer to nodes in the next layer. More complex neural network topologies are also used, such as convolutional neural networks in which intermediate or hidden layers perform convolutions to convolve the input before passing it to the next layer such as to identify features like edges or objects in an image. Recurrent neural networks differ in that outputs from node of a layer may not be simply forwarded to the next layer but may feed output of a node's layers back into itself, retaining a sort of memory. This makes recurrent neural networks particularly useful for identifying patterns in sequences of data, such as handwriting or speech recognition, genomics, language translation, and sequential image processing. But, training recurrent neural networks can be a very time-consuming and computationally expensive process, as it typically involves training over a very large data set to train a network to generalize well over data not seen during training. Further, the number of sequential input samples used during each training step (often selected using a sliding or stepped window) is directly proportional to the training time, computational expense, and memory needed to train the recurrent neural network. For reasons such as these, it is desirable to manage and improve the efficiency of training recurrent neural networks.

### BRIEF DESCRIPTION OF THE DRAWINGS

The claims provided in this application are not limited by the examples provided in the specification or drawings, but their organization and/or method of operation, together with features, and/or advantages may be best understood by reference to the examples provided in the following detailed description and in the drawings, in which:

FIG. 1 shows a training set for a recurrent neural network, according to an implementation.

FIG. 2 is a flow diagram of training a recurrent neural network, according to an implementation.

FIG. 3 is a flow diagram of a recurrent neural network architecture with a persistent history buffer, consistent with an example embodiment.

FIG. 4 is a block diagram showing training parameters as may be used in training a recurrent neural network, consistent with an example embodiment.

FIG. 5 is a flowchart of a method of training a recurrent neural network that maintains temporal congruity of a buffer between training batches, consistent with an example embodiment.

FIG. 6 shows an example of unrolling a recurrent neural network to train the recurrent neural network using a window of sequential input values, consistent with an example embodiment.

FIG. 7 shows a recurrent neural network configured to be trained at multiple points along a sequence of input values, consistent with an example embodiment.

FIG. 8 is a schematic diagram of a neural network, consistent with an example embodiment.

FIG. 9 shows a computing environment in which one or more trained neural image processing and/or filtering architectures may be employed, consistent with an example embodiment.

FIG. 10 shows a block diagram of a general-purpose computerized system, consistent with an example embodiment.

Reference is made in the following detailed description to accompanying drawings, which form a part hereof, wherein like numerals may designate like parts throughout that are corresponding and/or analogous. The figures have not necessarily been drawn to scale, such as for simplicity and/or clarity of illustration. For example, dimensions of some aspects may be exaggerated relative to others. Other embodiments may be utilized, and structural and/or other changes may be made without departing from what is claimed. Directions and/or references, for example, such as up, down, top, bottom, and so on, may be used to facilitate discussion of drawings and are not intended to restrict application of claimed subject matter. The following detailed description therefore does not limit the claimed subject matter and/or equivalents.

### DETAILED DESCRIPTION

In the following detailed description of example embodiments, reference is made to specific example embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made.

Features or limitations of various embodiments described herein, however important to the example embodiments in which they are incorporated, do not limit other embodiments, and any reference to the elements, operation, and application of the examples serve only to aid in understanding these example embodiments. Features or elements shown in various examples described herein can be combined in ways other than shown in the examples, and any such combinations is explicitly contemplated to be within the scope of the examples presented here. The following detailed description does not, therefore, limit the scope of what is claimed.

Recurrent neural networks are neural networks that do not simply feed computations forward from the input layer through hidden layers to the output layer, but instead include some feedback or retention of node outputs such that the neural network can retain some knowledge of past inputs. Recurrent neural networks are therefore a popular neural network architecture for applications that occur over a time series, such as handwriting recognition, genome analysis, language translation, and rendered sequential image processing. Training recurrent neural networks involves feeding the recurrent neural network with at least a portion of a time series of input data along with the desired output, such that the weights of the neural network nodes can be modified using traditional methods such as backpropagation of an observed difference between the actual output and desired output to improve the output performance of the neural network.

Training recurrent neural networks for complex time series such as computer vision and rendered graphics can be particularly time-consuming, and may typically involve training over a very large and diverse data set to train the recurrent neural network to provide the desired output for generalized input data not in the training set, such as new or arbitrary rendered image streams. One approach to training a recurrent neural network involves using small, manageable windows of a time series of data to perform training steps, such that each training step evaluates only the sequential elements within the window before adjusting the weights of the network nodes and proceeding to the next window.

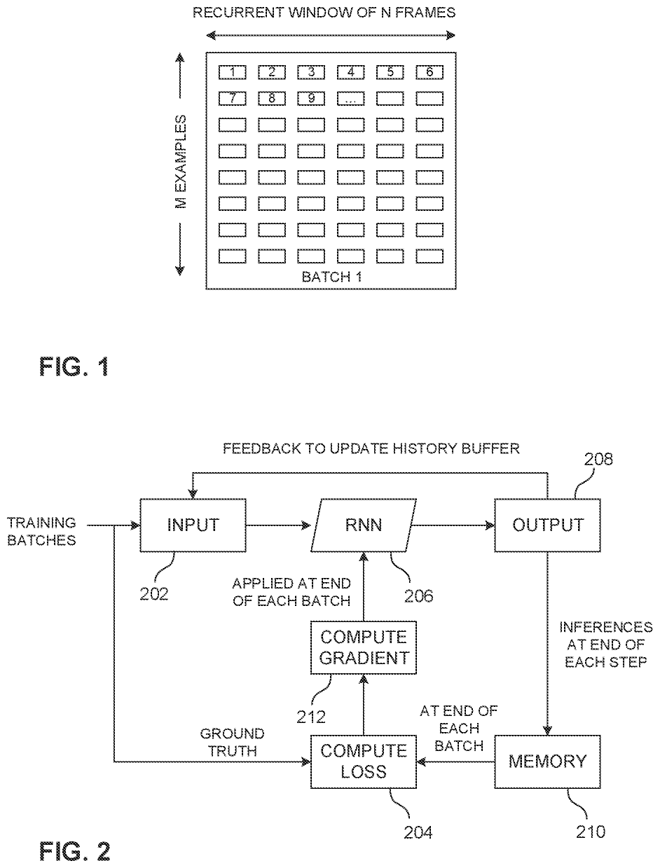

FIG. 1 shows a training set for a recurrent neural network, consistent with an implementation. As shown, a batch labeled “BATCH 1” comprises a number of sequential image frames of a rendered image sequence, such as a video game, augmented reality, computer-generated animation, or the like. A window of N frames is shown as being six frames long in this example, and the window in various further examples may be incremented by one to six frames after the training step is complete to provide windowed input including new image frames for the next training step. In some examples the window may be incremented by the size of the window, ensuring that every frame in the sequence is part of a training window but not reusing any frames in subsequent training steps. In alternate examples, the window may be incremented by fewer frames than the width of a window, preserving the recurrent neural network's ability to observe the sequential change between the last element of a training window and the next element in the sequence (such as frames 6 and 7 in the example of FIG. 1).

A training batch in this example may comprise more than one example sequence as denoted by “M EXAMPLES,” such as two different sequences of 24 sequential images each. In practical applications, an image sequence and a number of image sequences in a training batch may be much larger, and many training batches may be employed in a training epoch or training set. An order of batches in a training set may be further varied during the course of training, such as to prevent over-training a recurrent neural network to recognize a specific order of batches of training material. In a further example, training batches may be selected and/or configured such that a window of training parameters would comprise a full set of sequential samples, such as the batch being a multiple of six where the window size is six and the training window advances by six frames for a training iteration.

A window of six frames may be provided as an input to a recurrent neural network, which may generate six corresponding outputs in six steps. Output values of the six sequential frames may be stored in a memory for further processing. Six inferences comprising the difference between the observed outputs and the desired outputs or ground truths may be calculated, such that the inferences may be stored in a memory. Once the six frames in the window have been processed in the recurrent neural network and the six inferences have been stored, the next windows of six frames may be similarly processed and resulting outputs and inferences stored in memory. Once all windows in a training batch have been processed, stored inferences may be accumulated and used to train the recurrent neural network such as using backpropagation through time or other methods.

Each training frame or iteration in a training window may therefore involve providing an input and a ground truth to the neural network and accumulating inferences for each element of the window of training parameters, such as for each of six sequential rendered image frames in a window in the example of FIG. 1. The window size therefore may have a significant impact on the computational cost to train the recurrent neural network, on the time taken to train the recurrent neural network, and on the physical memory required to perform the training. Larger windows may result in a trained network that is better able to recognize effects in long series of input data, but as a practical matter may be limited due to computational, time, and memory costs.

FIG. 2 is a flow diagram of a process to train a recurrent neural network, consistent with an implementation. Here, training batches such as sequential rendered image frames of the example of FIG. 1 are provided to input block 202, and a corresponding ground truth or desired output values are provided to compute loss block 204. Training batches are provided as windowed sequential input data such as sequential rendered image frames to recurrent neural network (RNN) 206, which provides output value(s) 208 for each input frame in a window of training samples. Output values in this example may be stored in a memory 210 for each of the training steps in the window, such as for six steps in processing a training window of six sequential rendered image frames, and in a further example may also be used to update a history buffer provided as an input at 202. In a more detailed example of neural network ray tracing denoising in a rendered image sequence, a history buffer may maintain an accumulation of denoised output from previous frames, warped to be pixel-aligned for sequential image frames. The output 208 may be used to update the denoised image history buffer which is then provided as an input at 202 to recurrent neural network 206, along with one or more current noisy rendered image frames. This process may repeat for additional training windows in the batch (such as BATCH 1 of FIG. 1), until all windows of training samples in the batch have been processed.

At the end of a batch, output values stored in memory 210 and the ground truths may be used in compute loss block 204 to generate one or more error values that are calculated by a loss function. Such a loss function may determine the one or more error values by comparing predicted values provided at output value(s) 208 and stored in memory 210 to the ground truths provided as input values. An error value from the loss function may be used to compute one or more gradients at compute gradient block 212 that may be used to train the recurrent neural network 206, such as by using gradient descent backpropagation, backpropagation through time, or other such training methods to adjust the weights of nodes comprising the recurrent neural network 206. In a more detailed example, the loss computed at the end of a batch at compute loss block 204 may be computed using backpropagation through time such that the gradient from the last step in the batch is calculated and propagated backwards in time through each step to determine a final gradient using compute gradient block 212 that is applied to the weights of the recurrent neural network to reduce or minimize the calculated loss for the training batch.

Training a recurrent neural network using backpropagation through time such as in the example of FIG. 2 may consume significant memory to store outputs for all the time steps or windows for a given batch and their relevant computations for backpropagation, and may further consume significant computing resources to process the backpropagation through time on large windows. In examples where inputs are not time series of simple data such as the temperature of a sensor but are large inputs such as sequential rendered images having multiple dimensions and/or channels and high image resolution, memory and computational constraints typically limit training using methods such as those described in conjunction with FIGS. 1 and 2 to relatively small recurrent window sizes, such as five to eight prior sequential image frames.

However, limiting a recurrent window size may be undesirable in applications such denoising of sequential rendered image rays can limit an ability of the recurrent neural network to learn, as an accumulated history buffer such as that of FIG. 2 can take double or triple digit image frames to converge. Further, because the history buffer of FIG. 2 is reset after each recurrent window of training parameters to ensure the history buffer represents history from a single training sequence, history is not maintained across recurrent windows. A long recurrent window is therefore desirable to ensure that the recurrent neural network 206 sees a good distribution of accumulated history buffer levels including history buffer levels that are approaching convergence, but this is impractical given the memory and computational limits of training methods such as backpropagation through time using large sequential data such as sequential rendered images.

Some examples provided herein therefore provide a recurrent neural network training approach that uses relatively small recurrent window sizes, but presents the recurrent neural network with data regarding time steps outside the window using a history buffer. In a more detailed example, consecutive batches in a training epoch may be sequential and continuing from the previous batch, and a history buffer maintains persistent history information across training batches. A history buffer may be reset such as to a default state at the end of a training sequence that traverses training batches, enabling the history buffer to both retain sequence data across batches while resetting between different training sequences.

In another example, an ordered sequence of training sets may be partitioned into a sequence of training set batches, including one or more initial training set batches and a final training set batch. During training of initial history batches, a recurrent neural network computes inferences based on input features of the training set and the persistent history buffer, and stores the inferences. The persistent history buffer is also updated based on an output of the recurrent neural network. Once the final training batch is processed to compute inferences based on the input features of the training set and the updated state of the persistent history buffer, weights of the neural network are updated using gradient descent backpropagation based on the computed inferences and ground truth observations from the training set.

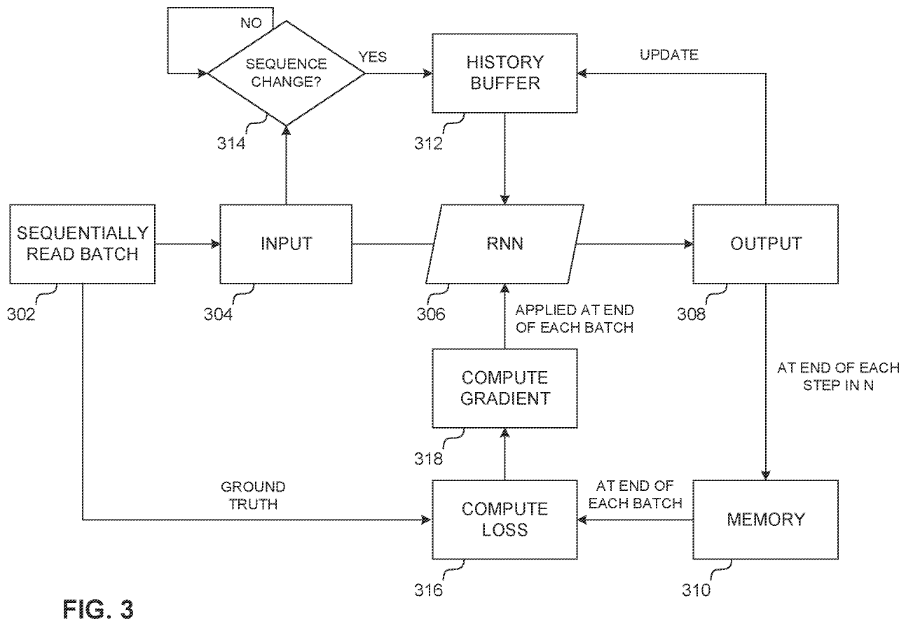

FIG. 3 is a flow diagram of a recurrent neural network architecture with a persistent history buffer, consistent with an example embodiment. Here, a sequentially-read batch 302 is provided to input 304, and may include both sequential input values for recurrent neural network 306 and associated tags or other information indicating which sequence the various input values are associated with as provided to sequence change block 314. The recurrent neural network 306 being trained processes the input data and generates an output 308, which at the end of each training step or window is stored in memory 310.

At the end of a batch of training samples, output values stored in memory 310 are sent to compute loss block 310 where error values are calculated using a loss function that compares the outputs of the recurrent neural network 306 to the ground truths or desired output provided as part of the sequentially-read batch 302. An error value determined by the loss function may be provided to compute gradient block 318, which uses the error value to calculate or more gradients that may be used to train the recurrent neural network 306 such as by using backpropagation through time to change the weights associated with nodes in the recurrent neural network. In a more detailed example, a loss computed at the end of a batch at compute loss block 316 may be computed using backpropagation through time such that the gradient from the last step in the batch is calculated and propagated backwards in time through each step to determine a final gradient. Such a final gradient may be computed using compute gradient block 318 that is applied to the weights of the recurrent neural network to minimize or reduce the calculated loss for the training batch.

Output values are further provided to a history buffer 312, which stores one or more states of the recurrent neural network, such as a history of inputs, history of hidden layer states, history of outputs, history of node weights, and/or the like. History buffer 312 may further feed back into the recurrent neural network 306 being trained, enabling the recurrent neural network to learn from past events outside the current training step or window of sequential inputs so long as it is not reset as a result of a training sequence change. In a more detailed example, when the batch changes and the loss is computed at block 316 and gradients computed at 308 are applied to the recurrent neural network such as via a backpropagation through time training algorithm, the history buffer 312 may maintain its history state until the input sequence is determined to have changed at sequence change block 314. Because the history buffer is not automatically reset at the end of a training window, training batch, or other arbitrary unit of input values, a history buffer architecture may enable recurrent neural network 306 to be trained on input value(s) spanning different batches, windows, or other such units of inputs. Such input values may span across a large rendered image sequence spanning multiple batches, for example, improving the recurrent neural network's ability to recognize and learn from long-term sequential data.

In an another example embodiment, compute loss 316 and compute gradient 318 may not be performed at the end of each batch, but may be calculated only for a last/final batch in a series of batches. In such an example, output values for a prior batch may be accumulated in an aggregated fashion in the history buffer 312, but are not explicitly individually stored in memory 310 for individual accumulation across batches. In a more detailed example, a series of four batches may be processed during training while only the output values of the fourth batch are stored in memory 310 and directly used for backpropagation. Nonetheless, output values 308 of the fourth batch may be influenced by history buffer 312 which is maintained across the four batches. Because the backpropagation training process or “backward pass” does not happen for three of the four batches in the series of training batches, backpropagation calculation time and memory consumed may be reduced by 75% over traditional methods.

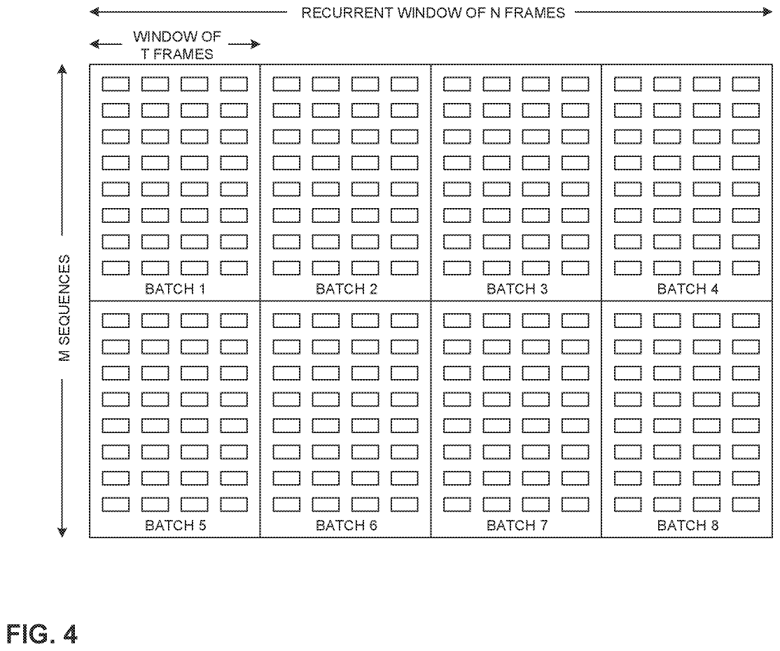

FIG. 4 is a block diagram showing training data sets as may be used in training a recurrent neural network, consistent with an example embodiment. FIG. 4 shows an epoch of training data, comprising eight consecutive numbered batches. Each batch of training data comprises 32 frames from a number M of sequential rendered image sequences, which in some further examples may comprise image sequences that are larger than a batch or that span across multiple batches. A window of T frames (in this example, comprising four frames) comprises a training window, which is the number of time steps or sequential input segments provided to the recurrent neural network at one time. The recurrent neural network may be “unrolled” or expanded to represent the number of steps in the window T during training, as described in greater detail in a later example.

To reduce overfitting a particular order of sequences, an order of sequences may be shuffled in some examples, such as by reading the number of sequences M in the training epoch and randomly ordering the sequences for use in training the recurrent neural network such as is shown in FIG. 3. In one such example, the eight batches shown in FIG. 4 may comprise five training sequences, which are not processed in numerical (1, 2, 3, 4, 5) order for each training epoch but are selected in random order for each training epoch, such as (3, 2, 5, 4, 1) for the first training epoch, (2, 5, 4, 1, 3) for the second epoch, etc.

In a further example, the training parameter set of FIG. 4 may further comprise a large recurrent window of N frames, which in this example comprises a 16 frame window of sequential frames. To reduce overfitting, a training process may select a random larger recurrent window of N frames from a training segment to apply during each epoch (or each round of training with the full set of training batches). By choosing a random sub-sequence of N length from a sequence (such as sequential image frames), content of the sequence may be somewhat varied between training epochs, further reducing the chances of overfitting the trained recurrent neural network to the training parameter set.

A history buffer in some examples may be maintained across training or backpropagation instances, and a batch may not necessarily correspond to a single backpropagation event. Backpropagation may occur at the end of a recurrent window of N frames as shown in FIG. 4, at the end of a small window of T frames, at the end of a series of sequential training data, at the end of a series of batches, or at another point in the training. Selection of a particular point in a training operation (e.g., relative to a series of input training data) to execute backpropagation (or similar adjustment to the recurrent neural network's weights) may be configurable in a further example, and may be based on factors such as input data type and size, memory available, computational cost of backpropagation for the input training data, and other such factors. This flexibility is provided in part due to the history buffer's ability to maintain a history of past recurrent neural network states such as past outputs across batches and other units of training data as desired.

The simplified example of FIG. 4 shows a relatively small number of training batches, frames per batch, larger recurrent window N of frames per sequence, and number M of sequences per training epoch for simplicity. In real-world examples, a training set may consist of significantly more sequences, batches, and frames per batch. Smaller window of frames T provided as a training window to the recurrent neural network may remain relatively small in some embodiments, such as 4-16 frames, reducing the computational burden and memory requirement of processing a window in training the recurrent neural network. Training methods described herein may nevertheless provide a result consistent with having a larger training window T by using a history buffer to store and incorporate previous training states in the same training sequence to the recurrent neural network, improving the training speed and the accuracy of the trained recurrent neural network.

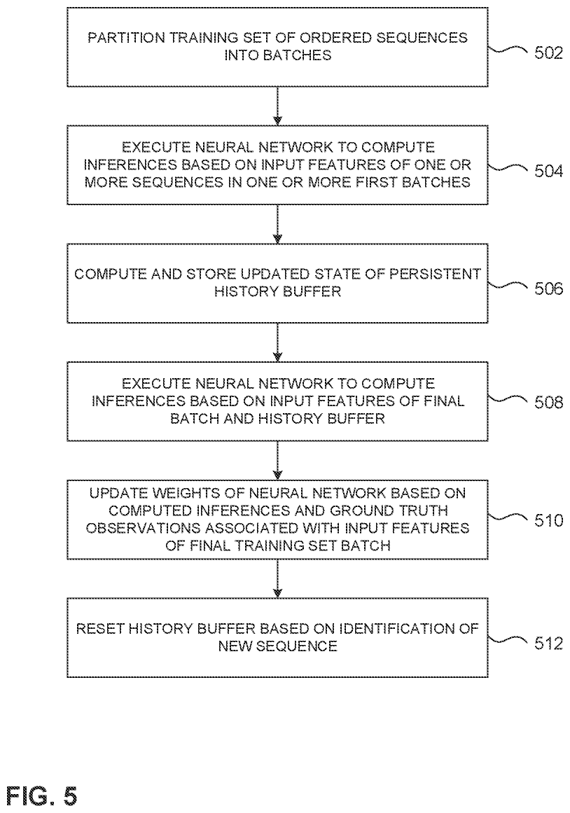

FIG. 5 is a flowchart of a method of training a recurrent neural network that maintains temporal congruity of a buffer between training batches, consistent with an example embodiment. At 502, a training set of data is partitioned into batches. The training set of data in a further example may comprise one or more ordered sequences of data and/or signals, such as consecutive rendered frames in a rendered image sequence, time series signals of collected sensor signals such as sequential captured images and/or sensor measurement values, or other such sequential signals. Batches in some examples are also ordered, such as where a single sequence of images spans multiple batches. A training set may comprise one or more features, such as the pixel color values of a rendered image or data captured from a sensor such as sensor voltages, currents, or impedance measurements captured from an industrial process. Batches may comprise an initial set of one or more training batches and a final batch, which in a further example may include multiple groups of initial and final batches.

A training set may further include a ground truth or desired output associated with an instance of input features, such as a desired denoising parameter, blending parameter, motion vector, or other parameter based on a rendered image sequence input. A neural network may be executed at 504 to generate one or more inferences or output values from the input features of one or more sequences in one or more first batches. The inferences are desirably the same as the ground truth or desired outputs, but may vary from the ground truth based on factors such as the degree of training the neural network has achieved and the similarity of the training input to previous training samples.

A persistent history buffer may be updated at 506 based on at least one state of the neural network, such as the input, output, hidden layer state, or other state of the neural network being trained. In a more detailed example, the persistent history buffer buffers the output of a recurrent neural network being trained, and updates with new sequential data samples used to train the recurrent neural network. In another example, the persistent history buffer buffers an input to the recurrent neural network being trained, such that more recent input features have a stronger influence on the state of the recurrent history buffer than less recent input features. In other examples, the persistent history buffer buffers one or more hidden layer states of the recurrent neural network, a combination of different inputs, outputs, and/or layers of the recurrent neural network, or other states of the recurrent neural network. A history buffer may be used at 508 along with input features of a final batch of the training parameter set to compute inferences or outputs, such that at least one final batch of training data has its inferences computed by incorporating history data from a history buffer during the training process. Training using the final batch of data therefore incorporates at least some influence from the one or more first batches of training data via the history buffer, which stores recurrent neural network state data derived at least in part from the first batches of input training data.

At 510, weights of a neural network may be updated based, at least in part, on computed inferences and ground truths provided with final batch of training data. Weights in a more detailed example may be calculated via gradient descent using error values derived from differences between observed inferences or output values and provided ground truths, such as shown in the example of FIG. 3. In a further example, backpropagation through time or other such methods are used to update weights of the neural network, such as using an “unrolled” recurrent neural network and a training window of sequential samples.

A history buffer can therefore be maintained across different batches of training data, such as where a single sequence of sequential rendered images spans across sequential batches, and provide the recurrent neural network with an influence of prior training batches and/or windows within the same training sequence. The history buffer may be reset at 512 responsive to detection of an end of a sequence, such as where an input feature set comprises a sequence identification tag that changes at the end of a sequence of image frames (e.g., a sequence of image frames spanning multiple batches). Resetting a history buffer may comprise in a further example resetting to a default state, such as an average value or a neutral value of the history buffer, thereby substantially removing an influence of the concluding sequence from the history buffer and preparing the history buffer to store history derived from a new sequential input sequence.

In a further embodiment consistent with FIG. 5, output values of one or more first batches at 504 may be accumulated in the persistent history buffer at 506 but are not explicitly stored in a memory for backpropagation. First batches in a series of batches contribute to the persistent history buffer and therefore influence computed inferences for the final batch at 508, but explicit storage of each output in memory and backpropagation calculations such as loss and gradient calculations may not be performed for the one or more first batches. After a final batch in a series of batches is processed at 508, a neural network may be updated using backpropagation or other suitable methods such as backpropagation through time at 510, using the output values stored in memory and the ground truths associated with the final batch. In a more detailed example, a series of four batches may be processed as a series of batches in training a recurrent neural network while output values from the first three batches are not explicitly stored in a memory. As pointed out above, such output values may nonetheless contribute to and be aggregated in a history buffer. Output values from a fourth, final batch may be stored in a memory and derived, at least in part, from the recurrent neural network using a history maintained in the history buffer. Loss functions and gradients may be calculated based, at least in part, on stored output values of the fourth batch and ground truths provided as part of the training data. Processing of the first three batches may influence the recurrent neural network training using inferences and ground truths from the fourth batch via influence of the history buffer on the recurrent network when processing the fourth, final batch in the series of training data. Such a process may then be repeated for additional series of batches, such as additional series of four batches of training data, reducing memory costs and backpropagation compute costs by 75%.

Although the example of FIG. 5 describes how a history buffer may be maintained across batches of sequential input training data, a history buffer may be similarly used in other examples to span different units of sequential input training data, such as sequential or overlapping windows of training data. In one such example, the history buffer is maintained across sequential windows of training data in a batch, and is reset at the end of the sequence irrespective of whether the sequential windows of image sequence training data span multiple batches.

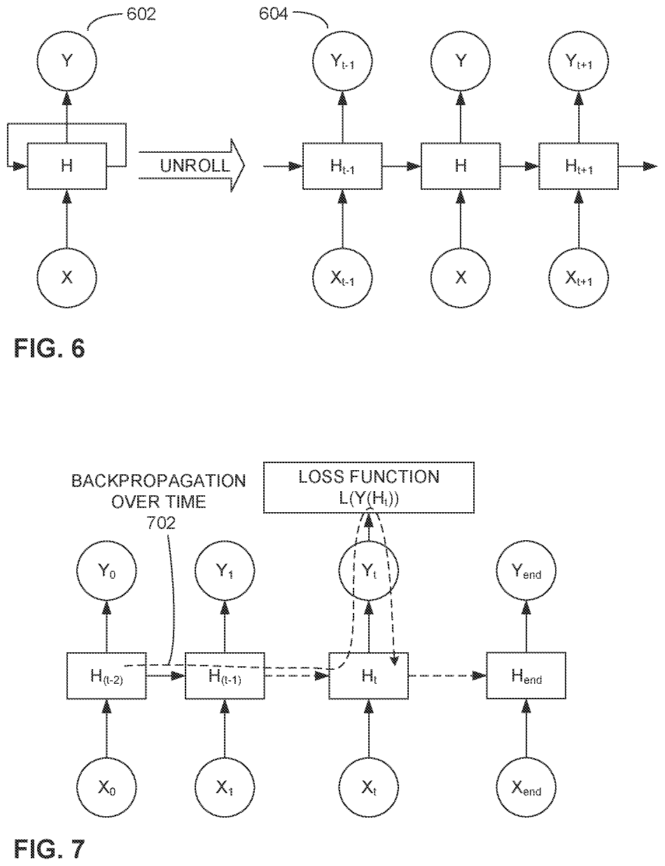

FIG. 6 shows an example of unrolling a recurrent neural network to train the recurrent neural network using a window of sequential input data, consistent with an example embodiment. Here, a recurrent neural network having sequential inputs X and generating sequential outputs Y is shown, where H is the state of a recurrent neural network with a given input used to generate an output Y. The state H of the recurrent neural network may include the state of one or more input nodes in response to an input, the state of one or more intermediate layers in response to the input, the state of the output Y in response to the input and/or intermediate nodes, or any combination thereof. Inputs to the neural network in this example include both network state data H from a prior time and the input X. There are many variations of input formats X, output formats Y, and network node formats and configurations that will work to generate a useful result in different embodiments. In the example of FIG. 6, the recurrent neural network 602 is also shown unrolled over time at 604, reflecting how information from the neural network state H₍ₜ₎ at time (t) may derive output Y₍ₜ₎ from input X₍ₜ₎, and may be retained and used with the subsequent input Xₜ₊₁ to produce the subsequent output Yₜ₊₁, such as within a window of sequential training inputs. The outputs Y over time are therefore dependent not only on the current inputs at each point in the sequence, but also on the state of the neural network up to that point in the sequence, such as previous outputs Y or outputs of one or more other network nodes such as hidden layers. The weights of the neural network nodes in some examples remain the same for all steps in a window of training data, and are updated upon completion of evaluation of each element of training data in the window by computing gradients and backpropagating them through the neural network.

Using a prior state of a current neural network as well as an input makes the neural network a recurrent neural network and makes it well-suited to evaluate input data where sequence and order is important, such as natural language processing (NLP), sequential image processing, machine translation, and the like. In a more detailed example, the recurrent neural network of FIG. 6 can be used to provide output tensors Y for a sequence of rendered image inputs X such as blending coefficients for a warped image history buffer, level of detail coefficients for a trilinear denoising filter, and other such image filtering or processing outputs. Similarly, the recurrent neural network of FIG. 6 can be trained by providing the known or ground truth desired blending coefficients, filter coefficients, or other desired outputs Y with the input training data X, with the difference between observed outputs and expected inputs or ground truth provided as an error signal via backpropagation over time to train the recurrent neural network to produce the desired end result.

FIG. 7 shows a recurrent neural network configured to be trained at multiple points along a sequence of inputs, consistent with an example embodiment. Here, the output Y, at a point Hₜ in the input sequence (between H₀ and H_{end}) such as at the end of a training window, a training batch, or a sequence of training data is compared to a desired output at that point in the training sequence. Training in one example is achieved using a loss function that represents the error between the produced output and the desired or expected output at a point Hₜ, with the loss function derived from a window of sequential training data ending at time Hₜ applied to the recurrent neural network nodes at Hₜ via backpropagation over time as shown at 702. The backpropagated loss function signal is used within the neural network at Hₜ using data from ht and prior training samples Hₜ₋₁ and Hₜ₋₂ within the training window to train or modify weights or coefficients of the recurrent neural network to produce the desired output, but with consideration of the training already achieved using previous training epochs or data sets. Many algorithms and methods for doing so are available, and will produce useful results here.

Various parameters in the examples presented herein, such as sequential rendered image stream filter parameters including blending coefficients, denoising or trilinear filter parameters, and other such parameters, may be determined using machine learning techniques such as a trained neural network. In some examples, a neural network may comprise a graph comprising nodes to model neurons in a brain. In this context, a “neural network” means an architecture of a processing device defined and/or represented by a graph including nodes to represent neurons that process input signals to generate output signals, and edges connecting the nodes to represent input and/or output signal paths between and/or among neurons represented by the graph. In particular implementations, a neural network may comprise a biological neural network, made up of real biological neurons, or an artificial neural network, made up of artificial neurons, for solving artificial intelligence (AI) problems, for example. In an implementation, such an artificial neural network may be implemented by one or more computing devices such as computing devices including a central processing unit (CPU), graphics processing unit (GPU), digital signal processing (DSP) unit and/or neural processing unit (NPU), just to provide a few examples. In a particular implementation, neural network weights associated with edges to represent input and/or output paths may reflect gains to be applied and/or whether an associated connection between connected nodes is to be excitatory (e.g., weight with a positive value) or inhibitory connections (e.g., weight with negative value). In an example implementation, a neuron may apply a neural network weight to input signals, and sum weighted input signals to generate a linear combination.

In one example embodiment, edges in a neural network connecting nodes may model synapses capable of transmitting signals (e.g., represented by real number values) between neurons. Responsive to receipt of such a signal, a node/neural may perform some computation to generate an output signal (e.g., to be provided to another node in the neural network connected by an edge). Such an output signal may be based, at least in part, on one or more weights and/or numerical coefficients associated with the node and/or edges providing the output signal. For example, such a weight may increase or decrease a strength of an output signal. In a particular implementation, such weights and/or numerical coefficients may be adjusted and/or updated as a machine learning process progresses. In an implementation, transmission of an output signal from a node in a neural network may be inhibited if a strength of the output signal does not exceed a threshold value.

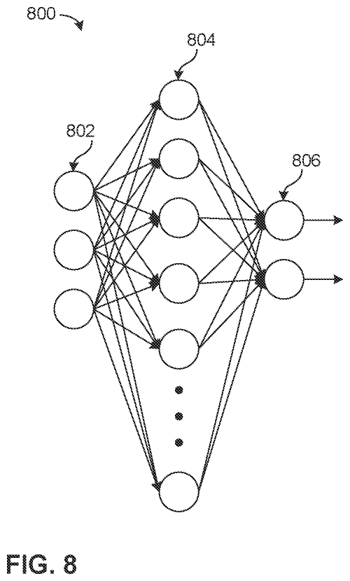

FIG. 8 is a schematic diagram of a neural network 800 formed in “layers” in which an initial layer is formed by nodes 802 and a final layer is formed by nodes 806. All or a portion of features of neural network 800 may be implemented various embodiments of systems described herein. Neural network 800 may include one or more intermediate layers, shown here by intermediate layer of nodes 804. Edges shown between nodes 802 and 804 illustrate signal flow from an initial layer to an intermediate layer. Likewise, edges shown between nodes 804 and 806 illustrate signal flow from an intermediate layer to a final layer. Although FIG. 8 shows each node in a layer connected with each node in a prior or subsequent layer to which the layer is connected, i.e., the nodes are fully connected, other neural networks will not be fully connected but will employ different node connection structures. While neural network 800 shows a single intermediate layer formed by nodes 804, it should be understood that other implementations of a neural network may include multiple intermediate layers formed between an initial layer and a final layer.

According to an embodiment, a node 802, 804 and/or 806 may process input signals (e.g., received on one or more incoming edges) to provide output signals (e.g., on one or more outgoing edges) according to an activation function. An “activation function” as referred to herein means a set of one or more operations associated with a node of a neural network to map one or more input signals to one or more output signals. In a particular implementation, such an activation function may be defined based, at least in part, on a weight associated with a node of a neural network. Operations of an activation function to map one or more input signals to one or more output signals may comprise, for example, identity, binary step, logistic (e.g., sigmoid and/or soft step), hyperbolic tangent, rectified linear unit, Gaussian error linear unit, Softplus, exponential linear unit, scaled exponential linear unit, leaky rectified linear unit, parametric rectified linear unit, sigmoid linear unit, Swish, Mish, Gaussian and/or growing cosine unit operations. It should be understood, however, that these are merely examples of operations that may be applied to map input signals of a node to output signals in an activation function, and claimed subject matter is not limited in this respect.

Additionally, an “activation input value” as referred to herein means a value provided as an input parameter and/or signal to an activation function defined and/or represented by a node in a neural network. Likewise, an “activation output value” as referred to herein means an output value provided by an activation function defined and/or represented by a node of a neural network. In a particular implementation, an activation output value may be computed and/or generated according to an activation function based on and/or responsive to one or more activation input values received at a node. In a particular implementation, an activation input value and/or activation output value may be structured, dimensioned and/or formatted as “tensors”. Thus, in this context, an “activation input tensor” as referred to herein means an expression of one or more activation input values according to a particular structure, dimension and/or format. Likewise in this context, an “activation output tensor” as referred to herein means an expression of one or more activation output values according to a particular structure, dimension and/or format.

In particular implementations, neural networks may enable improved results in a wide range of tasks, including image recognition, speech recognition, just to provide a couple of example applications. To enable performing such tasks, features of a neural network (e.g., nodes, edges, weights, layers of nodes and edges) may be structured and/or configured to form “filters” that may have a measurable/numerical state such as a value of an output signal. Such a filter may comprise nodes and/or edges arranged in “paths” and are to be responsive to sensor observations provided as input signals. In an implementation, a state and/or output signal of such a filter may indicate and/or infer detection of a presence or absence of a feature in an input signal.

In particular implementations, intelligent computing devices to perform functions supported by neural networks may comprise a wide variety of stationary and/or mobile devices, such as, for example, automobile sensors, biochip transponders, heart monitoring implants, Internet of things (IoT) devices, kitchen appliances, locks or like fastening devices, solar panel arrays, home gateways, smart gauges, robots, financial trading platforms, smart telephones, cellular telephones, security cameras, wearable devices, thermostats, Global Positioning System (GPS) transceivers, personal digital assistants (PDAs), virtual assistants, laptop computers, personal entertainment systems, tablet personal computers (PCs), PCs, personal audio or video devices, personal navigation devices, just to provide a few examples.

According to an embodiment, a neural network may be structured in layers such that a node in a particular neural network layer may receive output signals from one or more nodes in an upstream layer in the neural network, and provide an output signal to one or more nodes in a downstream layer in the neural network. One specific class of layered neural networks may comprise a convolutional neural network (CNN) or space invariant artificial neural networks (SIANN) that enable deep learning. Such CNNs and/or SIANNs may be based, at least in part, on a shared-weight architecture of a convolution kernels that shift over input features and provide translation equivariant responses. Such CNNs and/or SIANNs may be applied to image and/or video recognition, recommender systems, image classification, image segmentation, medical image analysis, natural language processing, brain-computer interfaces, financial time series, just to provide a few examples.

Another class of layered neural network may comprise a recursive neural network (RNN) that is a class of neural networks in which connections between nodes form a directed cyclic graph along a temporal sequence. Such a temporal sequence may enable modeling of temporal dynamic behavior. In an implementation, an RNN may employ an internal state (e.g., memory) to process variable length sequences of inputs. This may be applied, for example, to tasks such as unsegmented, connected handwriting recognition or speech recognition, just to provide a few examples. In particular implementations, an RNN may emulate temporal behavior using finite impulse response (FIR) or infinite impulse response (IIR) structures. An RNN may include additional structures to control stored states of such FIR and IIR structures to be aged. Structures to control such stored states may include a network or graph that incorporates time delays and/or has feedback loops, such as in long short-term memory networks (LSTMs) and gated recurrent units.

According to an embodiment, output signals of one or more neural networks (e.g., taken individually or in combination) may at least in part, define a “predictor” to generate prediction values associated with some observable and/or measurable phenomenon and/or state. In an implementation, a neural network may be “trained” to provide a predictor that is capable of generating such prediction values based on input values (e.g., measurements and/or observations) optimized according to a loss function. For example, a training process may employ backpropagation techniques to iteratively update neural network weights to be associated with nodes and/or edges of a neural network based, at least in part on “training sets.” Such training sets may include training measurements and/or observations to be supplied as input values that are paired with “ground truth” observations or expected outputs. Based on a comparison of such ground truth observations and associated prediction values generated based on such input values in a training process, weights may be updated according to a loss function using backpropagation. The neural networks employed in various examples can be any known or future neural network architecture, including traditional feed-forward neural networks, convolutional neural networks, or other such networks.

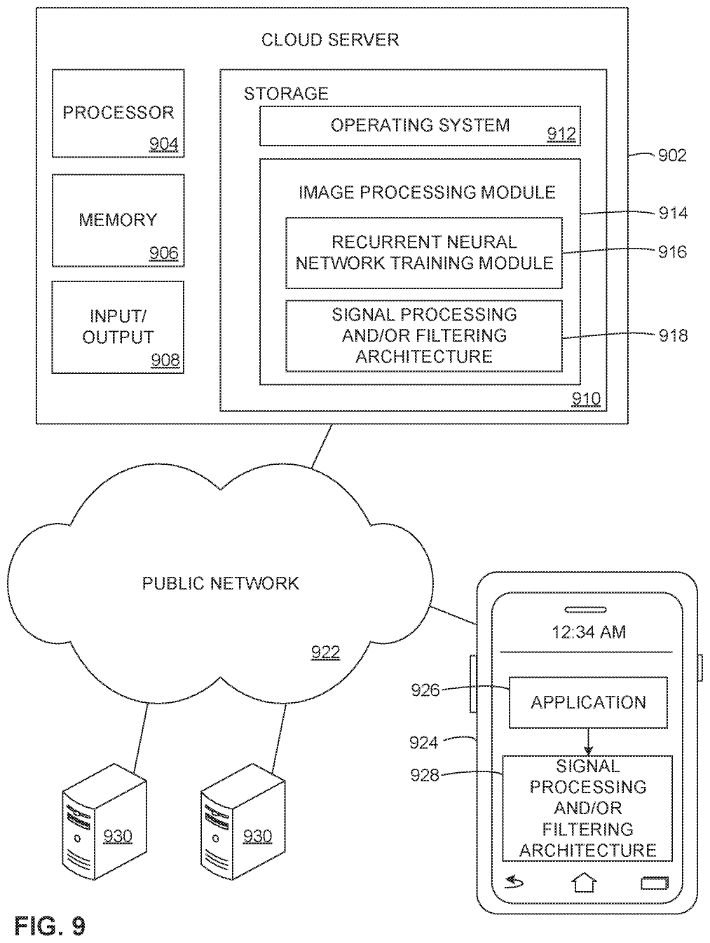

FIG. 9 shows a computing environment in which one or more trained neural image processing and/or filtering architectures may be employed, consistent with an example embodiment. Here, a cloud server 902 includes a processor 904 operable to process stored computer instructions, a memory 906 operable to store computer instructions, values, symbols, parameters, etc., for processing on the cloud server, and input/output 908 such as network connections, wireless connections, and connections to accessories such as keyboards and the like. Storage 910 may be nonvolatile, and may store values, parameters, symbols, content, code, etc., such as code for an operating system 912 and code for software such as image processing module 914. Image processing module 914 may comprise multiple signal processing and/or filtering architectures 918, which may be operable to render and/or process images. The image processing module may comprise a recurrent neural network training module 916, operable to use recurrent neural network training methods such as those employing a persistent history buffer as described in the examples herein to perform sequential image processing via signal processing and/or filtering architectures 918. Signal processing and/or filtering architectures may be available for processing images or other content stored on a server, or for providing remote service or “cloud” service to remote computers such as computers 930 connected via a public network 922 such as the Internet.

Smartphone 924 may also be coupled to a public network in the example of FIG. 9, and may include an application 926 that utilizes image processing and/or filtering architecture 928 for processing rendered images such as a video game, virtual reality application, or other application 926. Image processing and/or filtering architectures 918 and 928 may provide faster and more efficient computation of effects such as de-noising a ray-traced rendered image in an environment such as a smartphone using a trained recurrent neural network, and can provide for longer battery life due to reduction in power needed to impart a desired effect and/or compute a result. In some examples, a device such as smartphone 924 may use a dedicated signal processing and/or filtering architecture 928 for some tasks, such as relatively simple image rendering that does not require substantial computational resources or electrical power, and offloads other processing tasks to a signal processing and/or filtering architecture 918 of cloud server 902 for more complex tasks.

Signal processing and/or filtering architectures 918 and 928 of FIG. 9 and/or recurrent neural network training module 916 may, in some examples, be implemented in software, where various nodes, tensors, and other elements of processing stages may be stored in data structures in a memory such as 906 or storage 910. In other examples, signal processing and/or filtering architectures 918 and 928 and/or recurrent neural network training module 916 may be implemented in hardware, such as a recurrent neural network structure that is embodied within the transistors, resistors, and other elements of an integrated circuit. In an alternate example, signal processing and/or filtering architectures 918 and 928 and/or recurrent neural network training module 916 may be implemented in a combination of hardware and software, such as a neural processing unit (NPU) having software-configurable weights, network size and/or structure, and other such configuration parameters.

A trained neural network and other neural networks as described herein in particular examples, may be formed in whole or in part by and/or expressed in transistors and/or lower metal interconnects (not shown) in processes (e.g., front end-of-line and/or back-end-of-line processes) such as processes to form complementary metal oxide semiconductor (CMOS) circuitry. The various blocks, neural networks, and other elements disclosed herein may be described using computer aided design tools and expressed (or represented), as data and/or instructions embodied in various computer-readable media, in terms of their behavioral, register transfer, logic component, transistor, layout geometries, and/or other characteristics. Formats of files and other objects in which such circuit expressions may be implemented include, but are not limited to, formats supporting behavioral languages such as C, Verilog, and VHDL, formats supporting register level description languages like RTL, and formats supporting geometry description languages such as GDSII, GDSIII, GDSIV, CIF, MEBES and any other suitable formats and languages. Storage media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.).

Computing devices such as cloud server 902, smartphone 924, and other such devices that may employ signal processing and/or filtering architectures can take many forms and can include many features or functions including those already described and those not described herein.

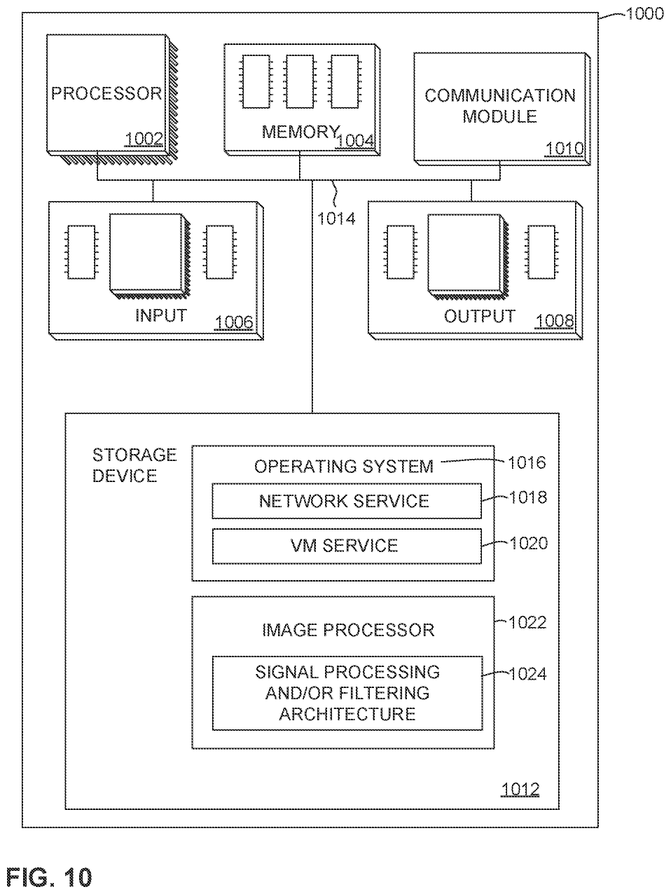

FIG. 10 shows a block diagram of a general-purpose computerized system, consistent with an example embodiment. FIG. 10 illustrates only one particular example of computing device 1000, and other computing devices 1000 may be used in other embodiments. Although computing device 1000 is shown as a standalone computing device, computing device 1000 may be any component or system that includes one or more processors or another suitable computing environment for executing software instructions in other examples, and need not include all of the elements shown here.

As shown in the specific example of FIG. 10, computing device 1000 includes one or more processors 1002, memory 1004, one or more input devices 1006, one or more output devices 1008, one or more communication modules 1010, and one or more storage devices 1012. Computing device 1000, in one example, further includes an operating system 1016 executable by computing device 1000. The operating system includes in various examples services such as a network service 1018 and a virtual machine service 1020 such as a virtual server. One or more applications, such as image processor 1022 are also stored on storage device 1012, and are executable by computing device 1000.

Each of components 1002, 1004, 1006, 1008, 1010, and 1012 may be interconnected (physically, communicatively, and/or operatively) for inter-component communications, such as via one or more communications channels 1014. In some examples, communication channels 1014 include a system bus, network connection, inter-processor communication network, or any other channel for communicating data. Applications such as image processor 1022 and operating system 1016 may also communicate information with one another as well as with other components in computing device 1000.

Processors 1002, in one example, are configured to implement functionality and/or process instructions for execution within computing device 1000. For example, processors 1002 may be capable of processing instructions stored in storage device 1012 or memory 1004. Examples of processors 1002 include any one or more of a microprocessor, a controller, a central processing unit (CPU), a graphics processing unit (GPU), a neural processing unit (NPU), an image signal processor (ISP), a digital signal processor (DSP), an application specific integrated circuit (ASIC), a field-programmable gate array (FPGA), or similar discrete or integrated logic circuitry.

One or more storage devices 1012 may be configured to store information within computing device 1000 during operation. Storage device 1012, in some examples, is known as a computer-readable storage medium. In some examples, storage device 1012 comprises temporary memory, meaning that a primary purpose of storage device 1012 is not long-term storage. Storage device 1012 in some examples is a volatile memory, meaning that storage device 1012 does not maintain stored contents when computing device 1000 is turned off. In other examples, data is loaded from storage device 1012 into memory 1004 during operation. Examples of volatile memories include random access memories (RAM), dynamic random access memories (DRAM), static random access memories (SRAM), and other forms of volatile memories known in the art. In some examples, storage device 1012 is used to store program instructions for execution by processors 1002. Storage device 1012 and memory 1004, in various examples, are used by software or applications running on computing device 1000 such as image processor 1022 to temporarily store information during program execution.

Storage device 1012, in some examples, includes one or more computer-readable storage media that may be configured to store larger amounts of information than volatile memory. Storage device 1012 may further be configured for long-term storage of information. In some examples, storage devices 1012 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 1000, in some examples, also includes one or more communication modules 1010. Computing device 1000 in one example uses communication module 1010 to communicate with external devices via one or more networks, such as one or more wireless networks. Communication module 1010 may be a network interface card, such as an Ethernet card, an optical transceiver, a radio frequency transceiver, or any other type of device that can send and/or receive information. Other examples of such network interfaces include Bluetooth, 4G, LTE, or 5G, WiFi radios, and Near-Field Communications (NFC), and Universal Serial Bus (USB). In some examples, computing device 1000 uses communication module 1010 to wirelessly communicate with an external device such as via public network 922 of FIG. 9.

Computing device 1000 also includes in one example one or more input devices 1006. Input device 1006, in some examples, is configured to receive input from a user through tactile, audio, or video input. Examples of input device 1006 include a touchscreen display, a mouse, a keyboard, a voice responsive system, video camera, microphone or any other type of device for detecting input from a user.

One or more output devices 1008 may also be included in computing device 1000. Output device 1008, in some examples, is configured to provide output to a user using tactile, audio, or video stimuli. Output device 1008, in one example, includes a display, a sound card, a video graphics adapter card, or any other type of device for converting a signal into an appropriate form understandable to humans or machines. Additional examples of output device 1008 include a speaker, a light-emitting diode (LED) display, a liquid crystal display (LCD or OLED), or any other type of device that can generate output to a user.

Computing device 1000 may include operating system 1016. Operating system 816, in some examples, controls the operation of components of computing device 1000, and provides an interface from various applications such as image processor 1022 to components of computing device 1000. For example, operating system 1016, in one example, facilitates the communication of various applications such as image processor 1022 with processors 1002, communication unit 1010, storage device 1012, input device 1006, and output device 1008. Applications such as image processor 1022 may include program instructions and/or data that are executable by computing device 1000. As one example, image processor 1022 may implement a neural signal processing and/or filtering architecture 1024 to perform image processing tasks or rendered image processing tasks such as those described above using a trained recurrent neural network, which in a further example comprises using signal processing and/or filtering hardware elements such as those described in the above examples. These and other program instructions or modules may include instructions that cause computing device 1000 to perform one or more of the other operations and actions described in the examples presented herein.

Features of example computing devices in FIGS. 9 and 10 may comprise features, for example, of a client computing device and/or a server computing device, in an embodiment. It is further noted that the term computing device, in general, whether employed as a client and/or as a server, or otherwise, refers at least to a processor and a memory connected by a communication bus. A “processor” and/or “processing circuit” for example, is understood to connote a specific structure such as a central processing unit (CPU), digital signal processor (DSP), graphics processing unit (GPU), image signal processor (ISP) and/or neural processing unit (NPU), or a combination thereof, of a computing device which may include a control unit and an execution unit. In an aspect, a processor and/or processing circuit may comprise a device that fetches, interprets and executes instructions to process input signals to provide output signals. As such, in the context of the present patent application at least, this is understood to refer to sufficient structure within the meaning of 35 USC § 112 (f) so that it is specifically intended that 35 USC § 112 (f) not be implicated by use of the term “computing device,” “processor,” “processing unit,” “processing circuit” and/or similar terms; however, if it is determined, for some reason not immediately apparent, that the foregoing understanding cannot stand and that 35 USC § 112 (f), therefore, necessarily is implicated by the use of the term “computing device” and/or similar terms, then, it is intended, pursuant to that statutory section, that corresponding structure, material and/or acts for performing one or more functions be understood and be interpreted to be described at least in FIG. 1 and in the text associated with the foregoing figure(s) of the present patent application.

The term electronic file and/or the term electronic document, as applied herein, refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

In the context of the present patent application, the terms “entry,” “electronic entry,” “document,” “electronic document,” “content,”, “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format).

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term “parameters” (e.g., one or more parameters), “values” (e.g., one or more values), “symbols” (e.g., one or more symbols) “bits” (e.g., one or more bits), “elements” (e.g., one or more elements), “characters” (e.g., one or more characters), “numbers” (e.g., one or more numbers), “numerals” (e.g., one or more numerals) or “measurements” (e.g., one or more measurements) refer to material descriptive of a collection of signals, such as in one or more electronic documents and/or electronic files, and exist in the form of physical signals and/or physical states, such as memory states. For example, one or more parameters, values, symbols, bits, elements, characters, numbers, numerals or measurements, such as referring to one or more aspects of an electronic document and/or an electronic file comprising an image, may include, as examples, time of day at which an image was captured, latitude and longitude of an image capture device, such as a camera, for example, etc. In another example, one or more parameters, values, symbols, bits, elements, characters, numbers, numerals or measurements, relevant to digital content, such as digital content comprising a technical article, as an example, may include one or more authors, for example. Claimed subject matter is intended to embrace meaningful, descriptive parameters, values, symbols, bits, elements, characters, numbers, numerals or measurements in any format, so long as the one or more parameters, values, symbols, bits, elements, characters, numbers, numerals or measurements comprise physical signals and/or states, which may include, as parameter, value, symbol bits, elements, characters, numbers, numerals or measurements examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

What is claimed is:

1. A method of training a neural network, the neural network comprising operators defined by weights associated with nodes in the neural network, comprising:
partitioning an ordered sequence of training sets over a recurrent window of training sets into a sequence of training set batches, each training set comprising one or more input features, the sequence of training set batches comprising a plurality of initial training set batches followed by a final training set batch;
for at least one of the initial training set batches:
executing the neural network to compute one or more inferences based on input features of training sets in at least one of the initial training set batches; and
computing an updated state of a persistent history buffer, wherein the neural network further computes the inferences in the at least one of the initial training set batches based on a state of the persistent history buffer, the persistent history buffer updated from execution of the neural network based on one or more preceding initial training set batches;
for at least the final training set batch:
executing the neural network to compute one or more inferences based on input features of the final training set batch, wherein the neural network further computes the one or more inferences in the final training set batch based on the updated state of the persistent history buffer computed from executing the neural network based on the input features of the at least one of the initial training set batches; and
updating the weights of the neural network using a gradient descent backpropagation based on the computed one or more inferences based on input features of the final training set batch and ground truth observations for the input features of the final training set batch.

2. The method of claim 1, and further comprising:
updating the weights of the neural network using the gradient descent backpropagation based on the computed one or more inferences based on input features of the at least one of the initial training set batches and ground truth observations for the input features of the at least one of the initial training set batches prior to executing the neural network to compute one or more inferences based on input features of the final training set batch.

3. The method of claim 1, wherein the weights are unchanged through execution of the neural network for prior to updating the weights based on the computed one or more inferences based on input features of the final training set batch and ground truth observations for the input features of the final training set batch.

4. The method of claim 1, wherein an accumulation of inferences computed in a preceding training batch are maintained in a history buffer, and the method further comprises:
resetting the history buffer; and
accumulating inferences computed in a training batch in the history buffer.

5. The method of claim 1, wherein the input features of the training set batches comprise features of images.

6. The method of claim 1, wherein the neural network comprises a recurrent neural network (RNN).

7. The method of claim 1, and further comprising:
warping an accumulation of inferences from execution of the neural network based on the one or more preceding initial training set batches; and
executing the neural network to compute the inferences in at least one training batch of the initial training set batches based on the warped accumulation of inferences.

8. A computing device, comprising:
a memory comprising one more storage devices; and
one or more processors coupled the memory, the one or more processors operable to:
partition an ordered sequence of training sets over a recurrent window of training sets into a sequence of training set batches, each training set comprising one or more input features, the sequence of training set batches comprising a plurality of initial training set batches followed by a final training set batch;
for at least one of the initial training set batches:
execute a neural network, the neural network comprising operators defined by weights associated with nodes in the neural network, to compute one or more inferences based on input features of training sets in at least one of the initial training set batches; and
compute an updated state of a persistent history buffer, wherein the neural network further computes the inferences in the at least one of the initial training set batches based on a state of the persistent history buffer, the persistent history buffer updated from execution of the neural network based on one or more preceding initial training set batches;
for at least the final training set batch:
execute the neural network to compute one or more inferences based on input features of the final training set batch, wherein the neural network further computes the one or more inferences in the final training set batch based on the updated state of the persistent history buffer computed from executing the neural network based on the input features of the at least one of the initial training set batches; and
update the weights of the neural network using a gradient descent backpropagation based on the computed one or more inferences based on input features of the final training set batch and ground truth observations for the input features of the final training set batch.

9. The computing device of claim 8, the one or more processors further operable to:
update the weights of the neural network using the gradient descent backpropagation based on the computed one or more inferences based on input features of the at least one of the initial training set batches and ground truth observations for the input features of the at least one of the initial training set batches prior to executing the neural network to compute one or more inferences based on input features of the final training set batch.

10. The computing device of claim 8, wherein the weights are unchanged through execution of the neural network for prior to updating the weights based on the computed one or more inferences based on input features of the final training set batch and ground truth observations for the input features of the final training set batch.

11. The computing device of claim 8, wherein an accumulation of inferences computed in a preceding training batch are maintained in a history buffer, and the one or more processors are further operable to:
reset the history buffer; and
maintain inferences computed in a training batch in the history buffer.

12. The computing device of claim 8, wherein the input features of the training set batches comprise features of images.

13. The computing device of claim 8, wherein the neural network comprises a recurrent neural network (RNN).

14. The computing device of claim 8, the one or more processors further operable to:
warp an accumulation of inferences from execution of the neural network based on one or more preceding initial training set batches; and
execute the neural network to compute the inferences in at least one training batch of the initial training set batches based on the warped accumulation of inferences.

15. A method of training a recurrent neural network, comprising:
receiving a windowed sequence of input tensors in an input layer of a recurrent neural network;
reading a sequence of output tensors from an output layer of the recurrent neural network corresponding to the windowed sequence of input tensors;
providing a sequence of ground truths corresponding to the windowed sequence of input tensors and representing a desired output;
training the recurrent neural network to predict the provided sequence of ground truths based on the received windowed sequence of input tensors by using backpropagation to adjust a weight of one or more activation functions linking one or more nodes of one or more layers of the recurrent neural network based on a difference between the sequence of output tensors and the ground truths; and
maintaining a persistent history buffer comprising one or more states of the recurrent neural network across multiple groups of input tensors, and providing data from the persistent history buffer to the recurrent neural network as an input while training the recurrent neural network.

16. The method of training a recurrent neural network of claim 15, further comprising resetting the persistent history buffer at end of a sequence.

17. The method of training a recurrent neural network of claim 15, wherein the groups of input tensors comprise windows of input tensors.

18. The method of training a recurrent neural network of claim 15, wherein the groups of input tensors combine training batches of input tensors.

19. The method of training a recurrent neural network of claim 15, wherein training the recurrent neural network comprises performing backpropagation at an end of a training batch.

20. The method of training a recurrent neural network of claim 15, further comprising randomizing at least one of a temporal position of a training window within a training sequence and an order of training sequences in a training epoch to reduce overfitting during training.
